(19) United States
(12) Patent Application Publication
(10) Pub. No.: US 2025/0314879 A1
(43) Pub. Date: Oct. 9, 2025

(54) OPTICAL SCANNING DEVICE AND IMAGE FORMING APPARATUS

(71) Applicant: CANON KABUSHIKI KAISHA, Tokyo (JP)

(72) Inventors: TAKU MUROTANI, Shizuoka (JP); HIROKI KATAYAMA, Shizuoka (JP)

(21) Appl. No.: 19/092,108

(22) Filed: Mar. 27, 2025

(30) Foreign Application Priority Data
Apr. 8, 2024 (JP) 2024-062051

(51) Int. Cl. G02B 26/12; G03G 15/04; G03G 15/043

(52) U.S. Cl. CPC G02B 26/123; G03G 15/04072; G03G 15/0435

(57) ABSTRACT

A scanning optical device includes a deflector including a polygon mirror for deflecting and scanning emitted laser lights in a scanning direction, a beam detector, an optical box and a lid. The optical box or the lid includes openings for permitting passing the laser lights. As viewed in the scanning direction, a wall is provided between first opening disposed closest to the deflector and the deflector. The wall is constituted by a first wall extended from the optical box toward the lid and a second wall extended from the lid toward the bottom surface. The wall portion is provided with a light passing portion for permitting passing the laser light deflected by the deflector. As the wall is viewed in an alignment direction of the openings, in a space between the lid and the bottom surface, substantially all areas excluding the light passing portion are covered by the wall.

### FIELD OF THE INVENTION AND RELATED ART

The present invention relates to a scanning optical device and an image forming apparatus, for example, a scanning optical device used in an image forming apparatus using electrophotographic type such as a laser printer and a digital copy machine.

Conventionally, a scanning optical device provided with a semiconductor laser, a coupling lens, a condensed light lens, a deflector, a scanning optical system, a frame and a cover, as disclosed for example in Japanese Patent Application Laid-Open No. 2023-083740, is known. The semiconductor laser emits a laser light. The coupling lens converts the laser light from the semiconductor laser into a beam. The condensed light lens condenses the beam from the coupling lens in a sub scanning direction. The deflector includes a rotatable polygon mirror which deflects the beam from the condensed light lens in a main scanning direction. The scanning optical system forms the light from the deflector into an image on an image surface. To the frame, the deflector and the scanning optical system are fixed. The cover covers at least a part of the frame to which the deflector is disposed.

In this technology, the frame includes a first wall provided with a first opening for permitting passing of the beam toward the rotatable polygon mirror, and the condensed light lens blocks the first opening. With this configuration, the first opening for permitting passing of the beam from the coupling lens toward the rotatable polygon mirror is blocked by the condensed light lens. Therefore, entering of dust near the coupling lens from the opening is prevented and it is possible to suppress that dust moves toward the rotatable polygon mirror and adheres to the rotatable polygon mirror. In addition, it has a configuration that the frame includes a second wall provided with a second opening for permitting passing of the beam reflected by the rotatable polygon mirror, and a scanning lens closest to the rotatable polygon mirror of the scanning optical system blocks the second opening. With this configuration, it is possible to suppress that dust near the scanning optical system moves toward the rotatable polygon mirror and adheres to the rotatable polygon mirror.

However, since the deflector for rotationally driving the rotatable polygon mirror is provided with a driving board on which a driver IC is mounted, upon driving the deflector, the driver IC generates heat. In the conventional configuration, by blocking the opening around the deflector with the cover, the walls, the condensed light lens and the scanning lens, a space around the deflector is hermetically blocked, and there is concern that ambient temperature around the deflector may rise. In a case in which the temperature around the deflector rise, for example, the frame formed of resin may be thermally deformed, and positions of optical components such as various types of lenses and reflecting mirrors, which are encased in the frame, may fluctuate.

When the positions of the optical components fluctuate, irradiating position of the light beam irradiated on a photosensitive drum is changed, positions of the light beams on the plurally provided photosensitive drums are misaligned, and color misalignment occurs in a color image, in which toner images of four colors are superimposed, which may result in deteriorating image quality.

### SUMMARY OF THE INVENTION

The present invention is conceived under such a background, and an object of the present invention is to suppress rise of ambient temperature around a deflector and to effectively realize dust proof around the deflector.

In order to solve the aforementioned problems, the present invention includes the following configurations.
(1) A scanning optical device comprising: a plurality of light sources; a deflector including a rotatable polygon mirror for deflecting and scanning a plurality of laser lights emitted from the plurality of the light sources in a main scanning direction; a beam detector configured to receive the laser light deflected by the deflector and output a signal; an optical box including a bottom surface on which the deflector is provided; and a lid member configured to cover the optical box, wherein the optical box or the lid member includes a plurality of opening portions for permitting passing of each of the plurality of the laser lights to outside the scanning optical device, wherein as viewed in the main scanning direction, a wall portion is provided between first opening portion which is disposed at a position closest to the deflector of the plurality of the opening portions and the deflector, and between an inner space of the optical box on which the deflector is provided and an inner space of the optical box provided with the first opening portion, wherein the wall portion is constituted by a first wall portion extended from the optical box toward the lid member and a second wall portion extended from the lid member toward the bottom surface, wherein the wall portion is provided with a first light passing portion which is a hole portion for permitting of passing the laser light deflected by the deflector and a second light passing portion which is a hole portion for permitting passing the laser light toward the beam detector of the laser light deflected by the deflector, and wherein as the wall portion is viewed in an alignment direction of the plurality of the opening portions, in a space between the lid member and the bottom surface, substantially all areas excluding the first light passing portion and the second light passing portion are covered by the wall portion.
(2) A scanning optical device comprising: a plurality of light sources; a deflector including a rotatable polygon mirror for deflecting and scanning a plurality of laser lights emitted from the plurality of the light sources in a main scanning direction; an optical box including a bottom surface on which the deflector is provided; and a lid member configured to cover the optical box, wherein the optical box or the lid member includes a plurality of opening portions for permitting passing of each of the plurality of the laser lights to outside the scanning optical device, and wherein as viewed in the main scanning direction, the plurality of the opening portions include a first opening portion which is disposed at a position closest to the deflector of the plurality of the opening portions and a second opening portion which is disposed at a position closer to the deflector next to the first opening portion; a first wall portion standing from the bottom surface or the lid member and provided between the first opening portion and the deflector; and a second wall portion standing from the bottom surface or the lid member and provided between the second opening portion and the deflector, wherein a height of the first wall portion is higher than a height of the second wall portion.
(3) An image forming apparatus for forming a toner image on a recording material, the image forming apparatus comprising: an image bearing member configured to bear an electrostatic latent image; a scanning optical device according to (1) and configured to form the electrostatic latent image; a developing means configured to develop the electrostatic latent image and form the toner image; and a transfer means configured to transfer the toner image to the recording material.

Further features of the present invention will become apparent from the following description of exemplary embodiments with reference to the attached drawings.

### BRIEF DESCRIPTION OF THE DRAWINGS

FIG. 1 is a perspective outline view illustrating a scanning optical device in Embodiments 1 through 3.

FIG. 2 is a cross-sectional outline view illustrating an oblique incidence optical system of the scanning optical device in the Embodiments 1 through 3.

FIG. 3, part (a) and part (b), includes a cross-sectional outline view illustrating a scanning optical system of the scanning optical device in the Embodiments 1 through 3, and a cross-sectional outline view illustrating air flows at opening portions of the scanning optical device.

FIG. 4, part (a) and part (b), includes a perspective outline view illustrating a simplified scanning optical device for simulation in the Embodiment 1, and a top outline view illustrating a simplified lid for the simulation.

FIG. 5, part (a) and part (b), includes top outline views illustrating simplified lids for the simulation in the Embodiment 1.

FIG. 6 is a view showing simulation results in the Embodiment 1.

FIG. 7, part (a) and part (b), includes a perspective outline view and a cross-sectional outline view illustrating dust proof walls of the scanning optical device in the Embodiment 1.

FIG. 8 is a view showing results of temperature rise of the scanning optical device in the Embodiment 1.

FIG. 9, part (a) and part (b), includes a cross-sectional outline view illustrating a scanning optical device showing a Modified Example of the Embodiment 1, and a cross-sectional outline view illustrating a scanning optical device in an Embodiment 2.

FIG. 10 is a cross-sectional outline view illustrating an image forming apparatus in an Embodiment 3.

### DESCRIPTION OF THE EMBODIMENTS

Embodiments of a scanning optical device according to the present invention will be described using the drawings. However, dimensions, material, shapes and relative dispositions of constituting components described in the Embodiments should be appropriately altered according to configurations of an apparatus to which the present invention is applied and various conditions, and are not intended to limit the scope of the present invention to the following Embodiments.

### Embodiment 1

An Embodiment 1 of the scanning optical device according to the present invention will specifically be described with reference to Figures.

### Scanning Optical Device

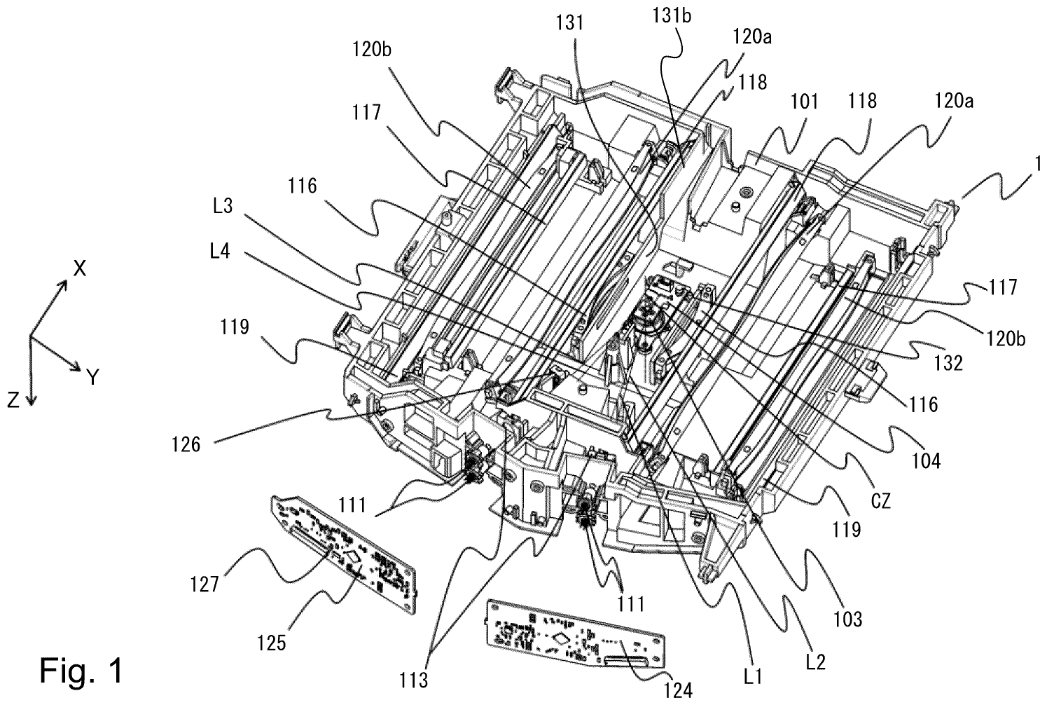

FIG. 1 is a perspective outline view describing a scanning optical device 1. In the scanning optical device 1 in the Embodiment 1, each laser luminous flux L1, L2, L3 and L4 emitted from a plurality of semiconductor lasers 111, which is a plurality of light sources, is scanned by a rotatable polygon mirror 103 provided to a deflector 104. With the scanned laser luminous fluxes L1, L2, L3 and L4, photosensitive drums of an unshown image forming apparatus are irradiated via optical members, respectively. The scanning optical device 1 includes the deflector 104 which includes the rotatable polygon mirror 103. The scanning optical device 1 includes a first imaging lens 116, second imaging lenses 120a and 120b, a BD lens 126, which are image forming members for the laser light and a first reflecting mirror 117, a second reflecting mirror 118 and a third reflecting mirror 119, which are reflection members (reflecting mirrors). Furthermore, the scanning optical device 1 includes an optical box 101 to which these are attached. The laser luminous fluxes L1, L2, L3 and L4 emitted from the semiconductor laser 111 become converged light by an anamorphic lens 113, in which a collimator lens and a cylindrical lens are integrally molded. Thereafter, the laser luminous fluxes L1, L2, L3 and L4 are then limited in luminous flux width by a sub scanning aperture diaphragm and a main scanning aperture diaphragm, which are not shown, and form an image in a line shape having a certain width on a deflecting and reflecting surface of the rotatable polygon mirror 103. On laser control boards 124 and 125, a chip which controls the semiconductor laser 111 is mounted. A beam detector (hereinafter, referred to as a BD) 127 is mounted on the laser control board 125. The laser luminous flux L4 is reflected, by the deflector 104 being rotationally driven about a rotational axis CZ, by the rotatable polygon mirror 103, deflected and scanned, and incident on the BD 127 after passing through the BD lens 126. At this time, based on a signal output from the BD 127 (BD signal), writing out control of images of each color is executed.

In addition, in order to prevent unwanted light, which is different from the laser light for scanning the unshown photosensitive drum and is generated by the laser light being refracted and reflected by the lenses, etc., from reaching the photosensitive drum and causing image defects, a stray light prevention wall 132 is provided. The stray light prevention wall 132 is provided between the first imaging lens 116 and the deflector 104, and a length and a height thereof are minimized to a size sufficient and necessary to suppress rise of ambient temperature due to the rotational drive of the deflector 104.

Incidentally, a direction parallel to the rotational axis CZ is defined as a Z direction, a direction in which the laser light is scanned by the rotatable polygon mirror 103, in other words, a longitudinal direction of the lens or the mirror is defined as an X direction, and a direction perpendicular to the X direction and the Z direction is defined as a Y direction. A dust proof wall 131 will be described later.

### Oblique Incidence Optical System

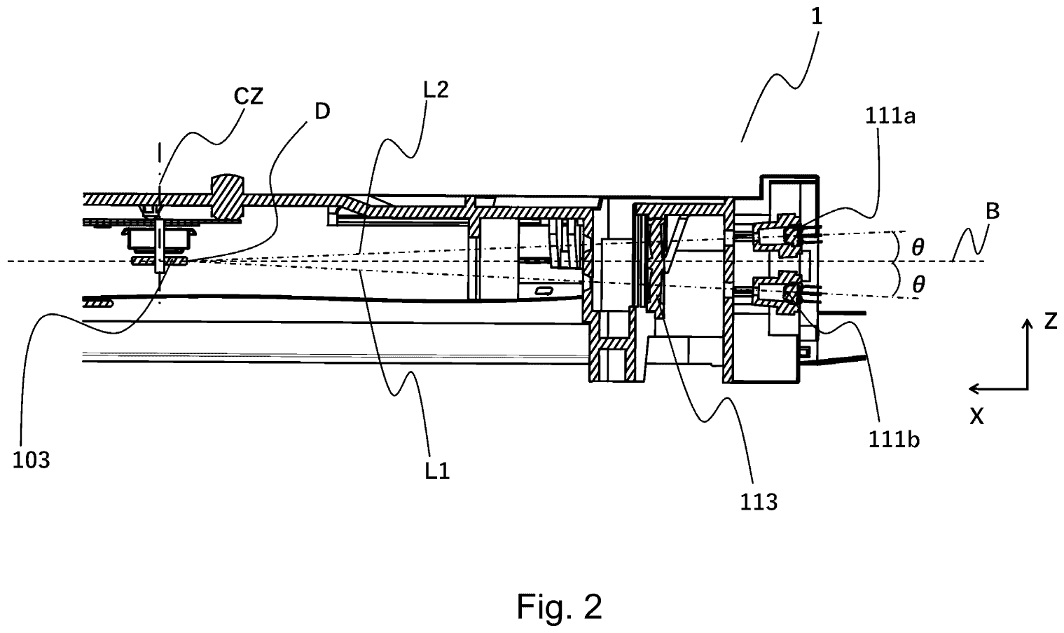

FIG. 2 is a cross-sectional outline view describing an oblique incidence optical system of the scanning optical device 1. The oblique incidence optical system is an optical system in which the laser luminous fluxes L1 and L2 are obliquely incident on a surface D of the rotatable polygon mirror 103. The incidence optical system, which is constituted by semiconductor lasers 111a and 111b and an anamorphic lens 113, are aligned vertically symmetrically with respect to an axis B, which is perpendicular to the rotational axis CZ. Of the plurality of light sources, the semiconductor laser 111a is a first light source disposed with inclined at a desired angle θ with respect to the axis B. The laser luminous flux L2 emitted from the semiconductor laser 111a is incident on the surface D of the rotatable polygon mirror 103 obliquely from an upside with the angle θ.

On the other hand, the semiconductor laser 111b is a second light source disposed with inclined at the desired angle θ with respect to the axis B. The laser luminous flux L1 emitted from the semiconductor laser 111b is incident on the surface D of the rotatable polygon mirror 103 obliquely from a downside with the angle θ. In this manner, by configuring the laser luminous fluxes L2 and L1 from the two semiconductor lasers 111a and 111b above and below to be incident obliquely from the upside and obliquely from the downside on the surface D, respectively, the laser luminous flux L2 and the laser luminous flux L1 become separable into respective optical passages above and below after being reflected by the rotatable polygon mirror 103. In the Embodiment 1, the oblique incidence optical system is described using the laser luminous fluxes L1 and L2, however, incidence optical system including light sources which emit the laser luminous fluxes L3 and L4 illustrated in FIG. 1 also has the same configuration.

### Scanning Optical System

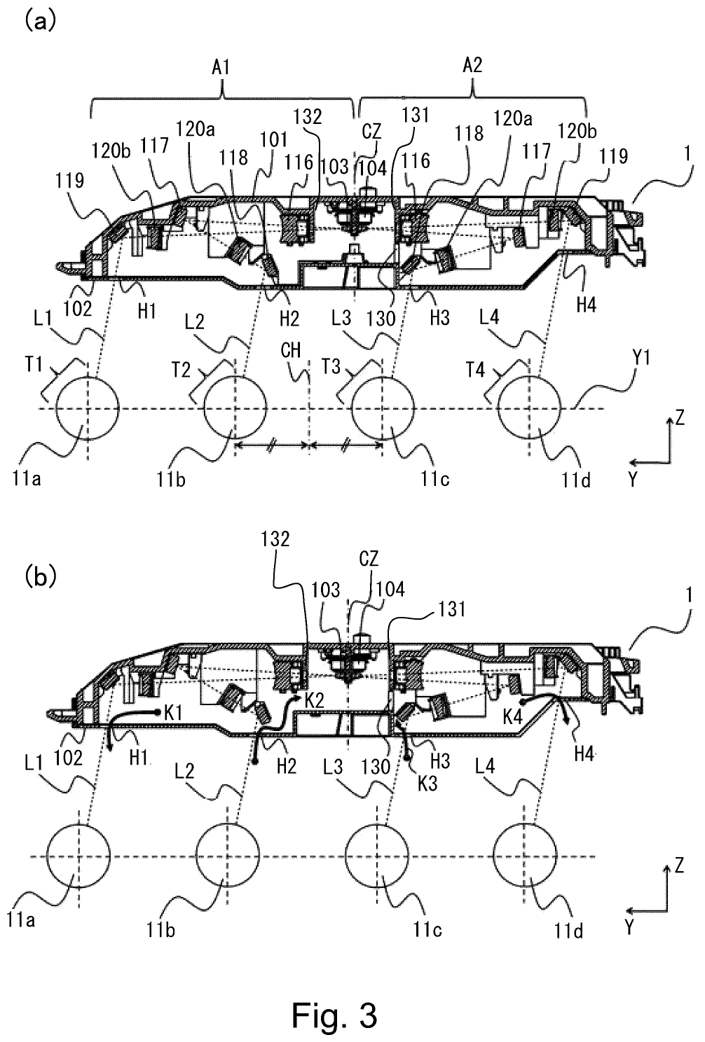

Next, using part (a) of FIG. 3, the scanning optical system after the laser luminous fluxes L1, L2, L3 and L4 are reflected by the rotatable polygon mirror 103 in the Embodiment 1 will be described. Part (a) of FIG. 3 is a sub scanning cross-sectional view of the scanning optical system illustrating optical passages of the laser luminous fluxes L1, L2, L3 and L4, which are deflected and scanned by the rotatable polygon mirror 103, until reaching photosensitive drums 11a, 11b, 11c and 11d.

The scanning optical device 1 deflects and scans each laser luminous flux L1, L2, L3 and L4 emitted from the unshown plurality of the light sources, with the rotatable polygon mirror 103, with dividing the laser luminous fluxes into a scanning area A1 and a scanning area A2, which is on an opposite side to the scanning area A1 centered on the rotational axis CZ of the rotatable polygon mirror 103. Since it is the oblique incidence optical system, in the Z direction, the laser luminous fluxes L1 and L3 are reflected to the downside and the laser luminous fluxes L2 and L4 are reflected to the upside by the rotatable polygon mirror 103. Thereafter, the laser luminous fluxes L1, L2, L3 and L4 are incident on the first imaging lens 116. The laser luminous fluxes L2 and L3 are reflected by the first reflecting mirror 117. Thereafter, after passing through the second imaging lens 120a, the laser luminous fluxes L2 and L3 are reflected again by the second reflecting mirror 118, pass through opening portions H2 and H3 provided in a lid 102 as a lid member, and reach the photosensitive drums 11b and 11c, respectively.

In addition, after passing through the second imaging lens 120b, the laser luminous fluxes L1 and L4 are reflected by the third reflecting mirror 119, and after passing through opening portions H1 and H4 provided in the lid 102, reach the photosensitive drums 11a and 11d, respectively. The first imaging lens 116 is a common lens for the laser luminous fluxes L1 and L2 and the laser luminous fluxes L3 and L4, respectively, while the second imaging lens 120a is disposed as a common lens for the laser luminous fluxes L2 and L3 and the second imaging lens 120b is disposed as a common lens for the laser luminous fluxes L1 and L4, respectively. Each imaging lens is fixed by an adhesive of UV light curing type, and each reflecting mirror is fixed by an urging member such as an unshown plate spring to the optical box 101. In addition, the lid 102 is attached to the optical box 101 by an unshown screw.

The deflector 104 including the rotatable polygon mirror 103 is disposed, in a horizontal direction, on a side closer to the photosensitive drum 11c from a midpoint CH of the two of the photosensitive drum 11b and the photosensitive drum 11c. Here, the horizontal direction is a direction of a straight line Y1 which connects rotational centers of the photosensitive drum 11a and the photosensitive drum 11d, which are the two most distant of the four photosensitive drums. The deflector 104 is disposed on the side closer to the photosensitive drum 11c from the midpoint CH of the two of the photosensitive drum 11b and the photosensitive drum 11c, and the laser luminous fluxes L1, L2, L3 and L4 are incident on the photosensitive drums 11a, 11b, 11c and 11d from an oblique direction. By this, it becomes possible to widely open spaces T1, T2, T3 and T4 on a left side in the figure of each photosensitive drum 11a, 11b, 11c and 11d. As a result, it becomes possible for unshown toner cartridges to dispose of toner containers in the spaces T1, T2, T3 and T4 and to fill sufficient amount of toner to the toner containers.

### Air Flows and Air Volumes at the Opening Portions

Next, using part (b) of FIG. 3, air flows and air volumes (air flow rates) at opening portions of the scanning optical device 1 will be described. Part (b) of FIG. 3 is a sub scanning cross-sectional view of the scanning optical device 1. The lid 102 includes the opening portions H1, H2, H3 and H4 for permitting passing of the laser luminous fluxes L1, L2, L3 and L4. Upon the deflector 104 being rotationally driven about the rotational axis CZ, the scanning optical device 1 draws in outside air inside the scanning optical device 1 from the opening portions H2 and H3 disposed relatively closer to the deflector 104, and air flows K2 and K3 are generated toward the rotatable polygon mirror 103 of the deflector 104. In the Y direction, the opening portion H3 is disposed closer to the deflector 104 compared to the opening portion H2. Therefore, the opening portion H3 is more susceptible to the rotation of the deflector 104 and the rotatable polygon mirror 103 compared to the opening portion H2, and the air flow K3 flowing in through the opening portion H3 is larger in the air volume than the air flow K2 flowing in through the opening portion H2. In addition, at the opening portions H1 and H4, by the rotational drive of the deflector 104, air is exhaled from the inside of the scanning optical device 1 to the outside, and air flows K1 and K4 are generated. In a case in which the image forming apparatus is used in an environment with a lot of dust, etc. in an atmosphere, the dust, etc. enters the inside of the scanning optical device 1 through the opening portions H2 and H3 of the scanning optical device 1.

### About a Simulation

Next, results of study of the inventors (Study 1) will be described. In a simulation, the followings are found. That is, as to the air flow flowing into the inside of the scanning optical device 1, when comparing the opening portion closer to the deflector 104 and the opening portion further from the deflector 104, the entering air volume becomes larger at the opening portion closer to the deflector 104, while the entering air volume becomes smaller at the opening portion further from the deflector 104.

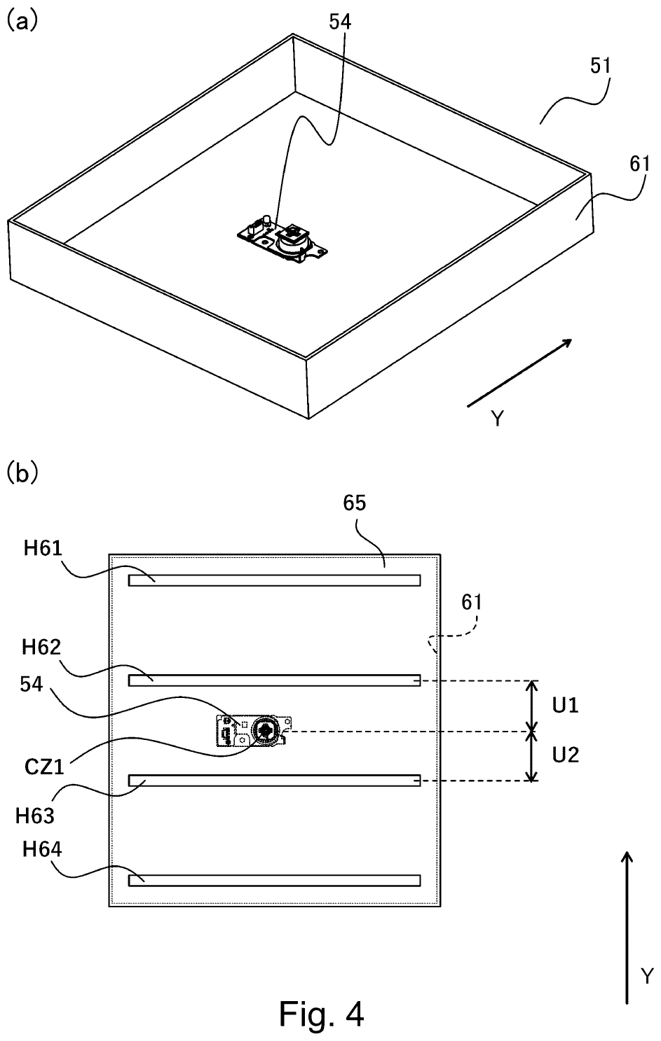

In Part (a) of FIG. 4, a simplified scanning optical device used in the simulation is illustrated. In a simplified scanning optical device 51, a deflector 54 is disposed approximately at a center of an approximately square optical box 61, and the optical box 61 is sealed by an unshown lid. In the simulation, in order to make air flows more visible, in a state in which the optical components such as lenses or reflecting mirrors are not present, three kinds of the lids are attached to the optical box and the air volumes (air flow rates) of the air flows at the opening portions with each lid are analyzed.

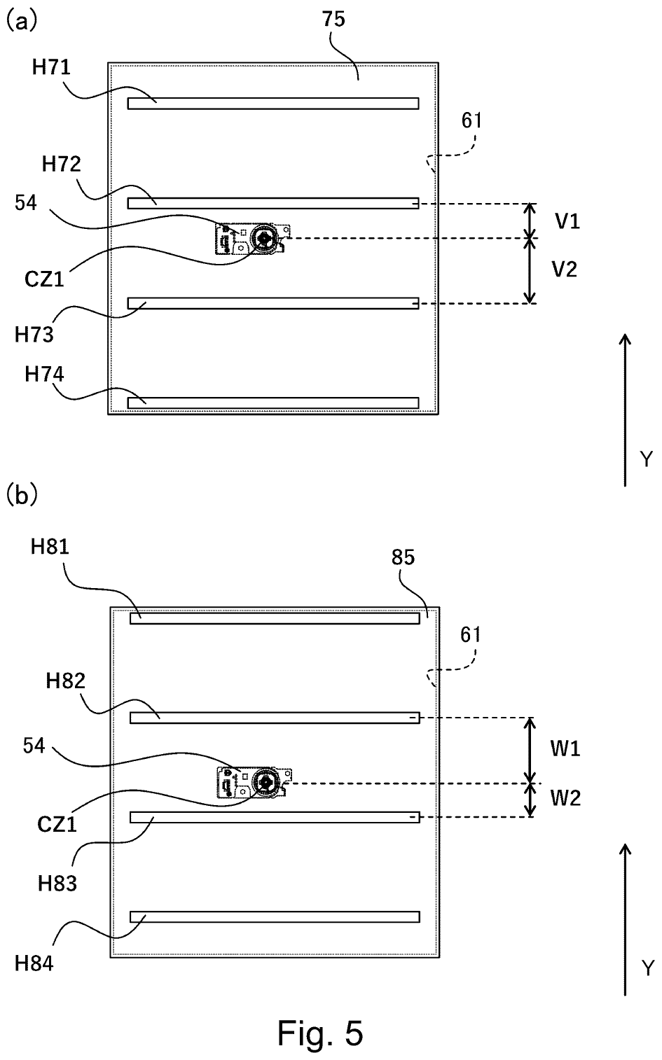

In part (b) of FIG. 4 through part (b) of FIG. 5, top views of simplified lids used in the simulation as viewed from above are illustrated. Part (b) of FIG. 4 shows a state in which an opening of the optical box 61 are covered by a lid 65, which includes opening portions H61, H62, H63 and H64. Incidentally, since the optical box 61 is covered by the lid 65, the deflector 54 is not actually visible and is illustrated by broken lines in the figure, and the same is also true in part (a) and part (b) of FIG. 5. In Part (b) of FIG. 4, in the Y direction, the deflector 54 is disposed approximately at a center between the opening portions H62 and H63. In addition, it is a configuration (Simulation 1) in which the openings H62 and H63 provided to the lid 65 are disposed, in the Y direction, with distances of U1 and U2 with respect to a rotation axis CZ1 of the deflector 54, respectively, and U1=U2.

Part (a) of FIG. 5 shows a state in which the opening of the optical box 61 is covered by a lid 75, which includes opening portions H71, H72, H73 and H74. Part (a) of FIG. 5 shows a configuration (Simulation 2) in which the openings H72 and H73 provided to the lid 75 are disposed, in the Y direction, with distances of V1 and V2 with respect to the rotation axis CZ1 of the deflector 54, respectively, and V1<V2. That is, the opening portion H72 is closer to the deflector 54 than the opening portion H73.

Part (b) of FIG. 5 shows a state in which the opening of the optical box 61 is covered by a lid 85, which includes opening portions H81, H82, H83 and H84. Part (b) of FIG. 5 shows a configuration (Simulation 3) in which the openings H82 and H83 provided to the lid 85 are disposed, in the Y direction, with distances of W1 and W2 with respect to the rotation axis CZ1 of the deflector 54, respectively, and W1>W2. That is, the opening portion H83 is closer to the deflector 54 than the opening portion H82.

Incidentally, in the Simulations 1 through 3, all openings are disposed so that intervals therebetween are the same. In the Y direction, including the two opening portions H61, H64, H71, H74, H81 and H84, which are disposed away from the deflector 54, the intervals between all of the opening portions are set to U1+U2=V1+V2=W1+W2.

### Results of the Simulations

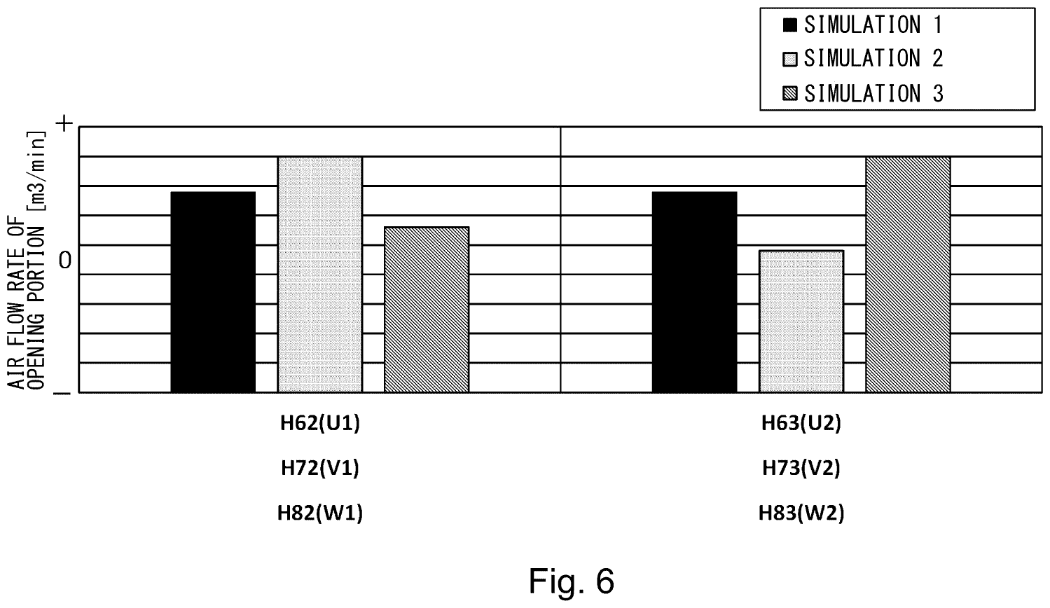

FIG. 6 shows results of the simulations. FIG. 6 shows an air volume [m³/min] at the opening portions of the lid, and a + side of a vertical axis represents an air flow direction flowing in from the outside to the inside of the scanning optical device. In FIG. 6, a graph on a left side shows the opening portions H62, H72 and H82 for permitting passing of the laser luminous flux L2, and the distances from the rotational axis CZ1 in the Y direction are U1, V1 and W1, respectively. A graph on a right side shows the opening portions H63, H73 and H83 for permitting passing of the laser luminous flux L3, and the distances from the rotational axis CZ1 in the Y axis direction are U2, V2 and W2, respectively.

In the Simulation 1 (part (b) of FIG. 4), since the opening portions H62 and H63 are disposed so as the distances of U1 and U2 with respect to the rotational axis CZ1 of the deflector 54 to be the same distance, i.e., U1=U2, the air volumes at the opening portion H62 and at the opening portion H63 become the same air volume.

In addition, in the Simulation 2 (part (a) of FIG. 5), since the opening portions H72 and H73 are disposed so as the distances of V1 and V2 with respect to the rotational axis CZ1 of the deflector 54 to be V1<V2, the air volume at the opening portion H72, which is closer to the rotational axis CZ1, is greater than that at the opening portion H73.

In addition, in the Simulation 3 (part (b) of FIG. 5), since the opening portions H82 and H83 are disposed so as the distances W1 and W2 with respect to the rotational axis CZ1 of the deflector 54 to be W1>W2, the air volume at the opening portion H82, which is further from the rotational axis CZ1, is smaller than that at the opening portion H83.

From the above-described results of the simulations, the following can be found. That is, it is found that of the two portions of the four opening portions provided to the scanning optical device, at the opening portion closer to the deflector 104, the air volume flowing into the scanning optical device becomes greater than that at the farther opening portion.

### Dust Proof Wall

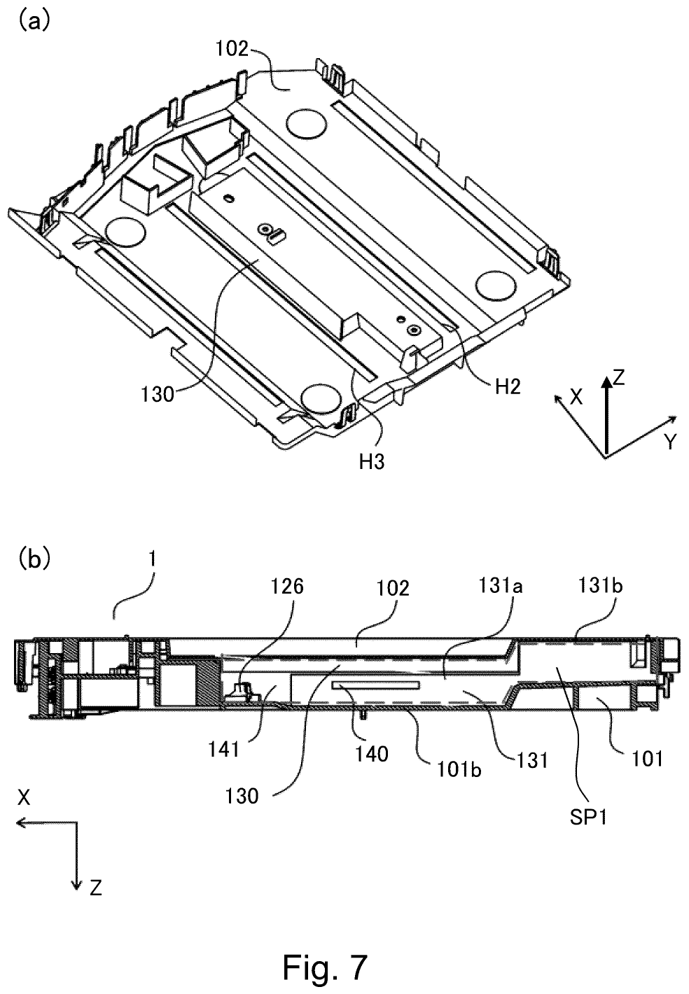

In part (a) of FIG. 7, a perspective view of the lid describing the dust proof wall is illustrated, and in part (b) of FIG. 7, a cross-sectional outline view of the scanning optical device 1 as a dust proof wall 130 and the dust proof wall 131 are viewed from the deflector 104 side in the −Y direction is illustrated. Air flows containing dust, etc. enter the inside of the scanning optical device 1 through the opening portions H2 and H3 of the lid 102. As shown in part (a) of FIG. 7, in the Embodiment 1, in order to effectively reduce an amount of dust reaching the rotatable polygon mirror 103 of the deflector 104, the lid 102 includes, in the Y direction, in a vicinity of the opening portion H3, which is the closest in distance from the deflector 104, the dust proof wall 130 as a wall portion. In more detail, the dust proof wall 130 is provided at a position between the opening portion H3 and the deflector 104 and closer to the opening portion H3 in a direction perpendicular to the main scanning direction (X direction). The dust proof wall 130 provided to the lid 102 is provided, parallel to the X direction, which is a longitudinal direction of the opening portion H3, to stand (is standing) toward the optical box 101.

Here, the opening portion H2 is farther from the deflector 104 in the Y direction than the opening portion H3, and the air volume at the opening portion H2 is smaller than that at the opening portion H3. Therefore, to a vicinity of the opening portion H2, a dust proof wall may not be provided, or a low standing wall, which is lower than the dust proof wall 130 on the opening portion H3 side, of a degree not to affect the air flow flowing in and out of the opening portion may be provided.

In addition, as shown in part (b) of FIG. 7, the dust proof wall 130 (a second wall portion) of the lid 102 is extended to a position in which the dust proof wall 130 does not have interference with the dust proof wall 131 (a first wall portion) standing from the bottom surface (an installation surface of the deflector 54) 101b of the optical box 101. The dust proof wall 131 provided to the optical box 101 includes a dust proof wall 131a and a dust proof wall 131b, which are provided parallel to the X direction and has different heights in the Z direction. Therefore, the dust proof wall is formed by the dust proof wall 130 provided to the lid 102 and the dust proof wall 131 provided to the optical box 101, and an added length of the dust proof wall 130 and the dust proof wall 131 in the X direction is approximately the same as a length of the opening portion H3. Incidentally, the added length of the dust proof wall 130 and the dust proof wall 131 may be longer than the length of the opening portion H3.

However, in the scanning optical device 1, in the area through which the unshown laser light passes, there is an area in which the dust proof wall is not present. For example, in a light passing portion 140 for the laser light being reflected by the rotatable polygon mirror 103 of the deflector 104, scanned and incident on the first imaging lens, and in a light passing portion 141 for the laser light being incident on the BD lens 126, the dust proof wall is not present in order not to block the laser light. Incidentally, the light passing portion 140 is an opening provided to the dust proof wall 131a.

In this manner, the wall portion constituted by the dust proof wall 131 and the dust proof wall 130 includes the first light passing portion 140, which is a hole portion for permitting passing of the laser light deflected by deflector 104, and the second light passing portion 141, which is a hole portion for permitting passing of the laser light toward the beam detector BD of the laser light deflected by the deflector 104.

And, as the wall portion is viewed in an alignment direction of the plurality of the opening portions H1 through H4, for a space SP1 between the lid 102 and the bottom surface 201a (an area enclosed by a dashed line in part (b) of FIG. 7), approximately all area is covered by the wall portion, except the first light passing portion 140 and the second light passing portion 141.

In the Embodiment 1, for the dust proof wall provided between the opening portion and the rotatable polygon mirror, the configuration of the two dust proof walls of the dust proof wall provided to the lid and the dust proof wall provided to the optical box is described, however, it may be a configuration in which the dust proof wall is provided only to the lid side, and in addition, it may be a configuration in which the dust proof wall is provided only to the optical box. In other words, in part (a) of FIG. 7, it is configured so that the dust proof wall 130 and the dust proof wall 131 are combined to be equivalent to one dust proof wall, however, it is not limited thereto. The dust proof wall 130 alone may be configured to be the dust proof wall which is the same as or longer than the length of the opening portion H3 in the main scanning direction, or the dust proof wall 131 alone may be configured to be the dust proof wall which is the same as or longer than the length of the opening portion H3 in the main scanning direction. Furthermore, in part (b) of FIG. 7, the dust proof wall 131 is constituted by the two dust proof walls 131a and 131b having different heights, however, it may be constituted by three or more of the dust proof walls. Furthermore, the dust proof wall 130 may also be constituted by a plurality of dust proof walls having different heights. In addition, the dust proof wall provided to the lid and the dust proof wall provided to the optical box do not have to be disposed in the same position in the Y direction in part (a) of FIG. 7, but may be disposed in different positions in the Y direction from each other.

As described above, according to the Embodiment 1, the air flows entering from the opening portion H2 side in part (a) of FIG. 7 may reach the rotatable polygon mirror of the unshown deflector. However, since the air volume of the air flow is smaller on the opening portion H2 side than that on the opening portion H3 side, risk of the rotatable polygon mirror being contaminated by dust is lower on the opening portion H2 side compared to that on the opening portion H3 side. Therefore, by providing the dust proof wall in the vicinity of the opening portion closer to the deflector, which has the higher risk, it becomes possible to effectively prevent the entering of dust.

### Temperature Rise of the Scanning Optical Device

As shown in part (a) of FIG. 7, etc., the dust proof wall 130 is provided only in the vicinity of the opening portion H3, which is closest in distance to the deflector 104. In the Y direction, for the opening portion H2, which is farther from the deflector 104 than the opening portion H3, the dust proof wall may not be provided thereto, or a low standing wall, which is lower than the dust proof wall 130 on the opening portion H3 side, of a degree not to affect the air flow flowing in and out of the opening portion, may be provided. However, in a case in which the standing wall is provided on the opening portion H2 side, a height and a length of the standing wall is set in an arbitrary shape with taking into account balance between the air volume at the opening portion and temperature rise in ambient temperature around the deflector. In addition, on the opening portion H2 side, the stray light prevention wall 132 shown in FIG. 1 is provided. In the scanning optical device 1, the unwanted light, which is different from the laser light for scanning the photosensitive drum 11 and is generated by the laser light being refracted and reflected by the lenses, etc., may reach the photosensitive drum 11 and cause image defect to occur. The stray light prevention wall 132 is a configuration for preventing the unwanted light from reaching the photosensitive drum 11, and is provided so as a length and a height thereof to be minimum, unlike the dust proof wall provided on the opening portion H2 side.

Next, results of study of the inventors (Study 2) will be described. In measurement results in which the ambient temperature around the deflector is measured by continuously driving the deflector of the scanning optical device, a configuration, in which the dust proof wall is disposed only in the vicinity of the opening portion closest to the deflector, and a configuration, in which the dust proof walls are disposed to both of the vicinities of the two opening portions disposed across the deflector, are compared. Then, it is found that the configuration in which the dust proof wall is disposed only in the vicinity of the opening portion closest to the deflector can reduce the ambient temperature around the deflector.

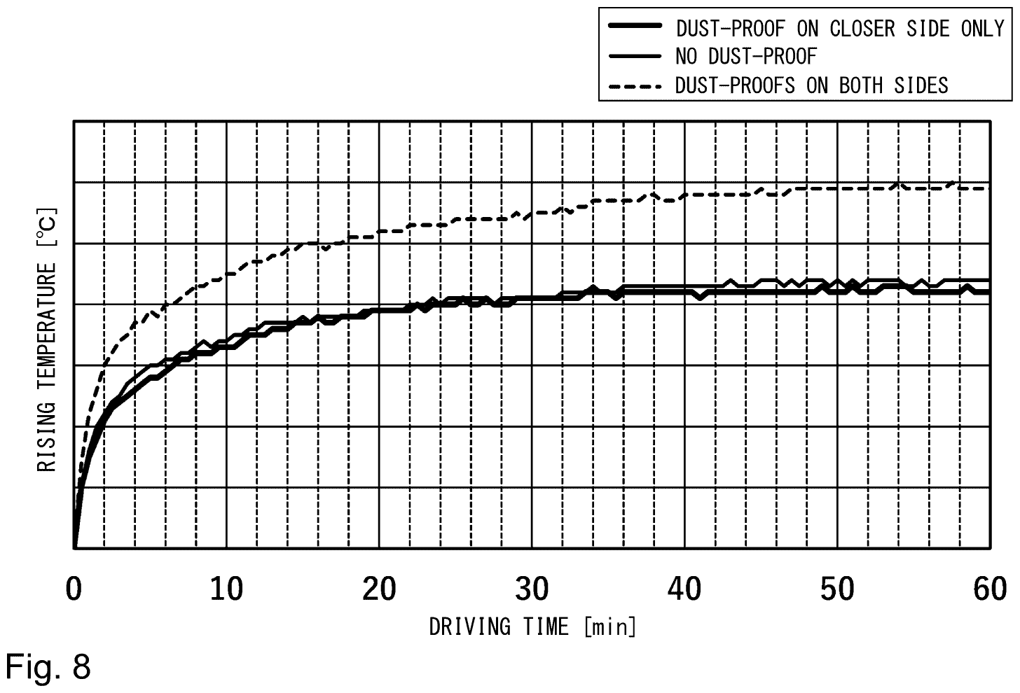

In FIG. 8, measurement results of the ambient temperature around the deflector when the deflector of the scanning optical device is continuously driven are shown. In FIG. 8, a vertical axis represents temperature rise [° C.] and a horizontal axis represents a driving time [min]. In FIG. 8, a thick solid line shows a temperature rise in a case in which a dust proof wall is provided only on the opening portion side closer to the deflector, a thin solid line shows a temperature rise in a case in which no dust proof wall is provided, and a broken line shows a temperature rise in a case in which dust proof walls similar to the dust proof wall 131 are provided on both sides of the deflector.

When the deflector is continuously driven for 60 minutes, the temperature rise of the ambient temperature around the deflector becomes higher in the configuration in which the dust proof walls are provided on both sides of the two openings across the deflector than in the configuration in which the dust proof wall is disposed only in the vicinity of the opening portion closest to the deflector. In addition, the temperature rise in the configuration in which the dust proof wall is disposed only in the vicinity of the opening portion closest to the deflector is the same as that in the configuration in which no dust proof wall is provided.

Using this configuration, by providing the dust proof wall only on one side and configuring the length and the height of the stray light prevention wall provided on the other side at a minimum, it becomes possible to suppress the rise in the ambient temperature around the deflector and effectively prevent dust from entering inside the scanning optical device from the outside air. In addition, by this, it becomes possible to provide a scanning optical device which can achieve both suppression of the temperature rise of the scanning optical device and dust proof performance and prevent the degradation of image quality.

### Modified Example

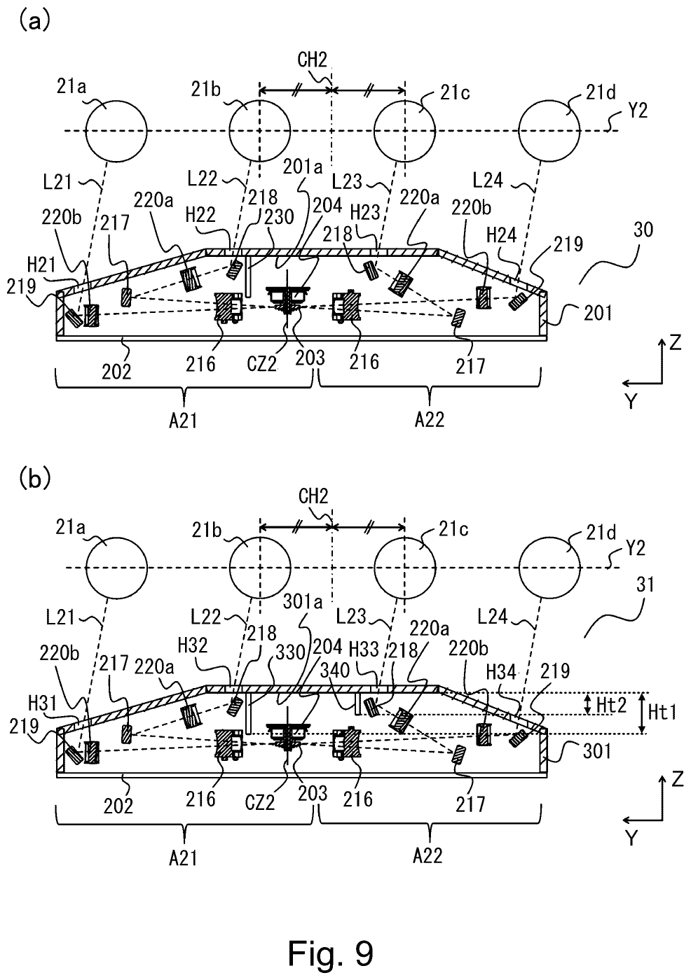

In the Embodiment described above, the opening portions are provided to the lid, and the dust proof wall for preventing the air flows flowing in through the opening portions of the lid from reaching the rotatable polygon mirror is exemplified, however, it is not limited thereto but the opening portion may be provided to the optical box. Part (a) of FIG. 9 is a sub scanning cross-sectional outline view describing a Modified Example of the Embodiment 1.

A scanning optical device 30 deflects and scans each laser luminous flux L21, L22, L23 and L24 emitted from an unshown plurality of light sources, by a rotatable polygon mirror 203, with dividing the laser luminous fluxes into a scanning area A21 and a scanning area A22, which is on an opposite side to the scanning area A21 centered on a rotation axis CZ2 of the rotatable polygon mirror 203.Since it is the oblique incidence optical system, in the Z direction, the laser luminous fluxes L21 and L23 are reflected to a downside and the laser luminous fluxes L22 and L24 are reflected upside by the rotatable polygon mirror 203.

Thereafter, the laser luminous fluxes L21, L22, L23 and L24 are incident on a first imaging lens 216. The laser luminous fluxes L22 and L23 are then reflected by a first reflecting mirror 217. Thereafter, after passing through a second imaging lens 220a, the laser luminous fluxes L22 and L23 are reflected again by a second reflecting mirror 218, pass through opening portions H22 and H23 provided to an optical box 201, and reach photosensitive drums 21b and 21c, respectively. In addition, after passing through a second imaging lens 220b, the laser luminous fluxes L21 and L24 are reflected by a third reflecting mirror 219 and after passing through opening portions H21 and H24 provided to the optical box 201, reach photosensitive drums 21a and 21d.

The first imaging lens 216 is a common lens for the laser luminous fluxes L21, L22, L23 and L24, while the second imaging lens 220a is disposed as a common lens for the laser luminous fluxes L22 and L23 and the second imaging lens 220b is disposed as a common lens for the laser luminous fluxes L21 and L24, respectively. Each imaging lens is fixed to the optical box 201 by an adhesive of UV light curing type, and each reflecting mirror is fixed to the optical box 201 by an urging member such as an unshown plate spring. In addition, a lid 202 is attached to the optical box 201 by an unshown screw. A deflector 204 including the rotatable polygon mirror 203 is disposed, in a horizontal direction, on a side closer to the photosensitive drum 21b from a midpoint CH2 of the two of the photosensitive drum 21b and the photosensitive drum 21c. Here, the horizontal direction is a direction of a straight line Y2 connecting rotational centers of the photosensitive drum 21a and the photosensitive drum 21d, which are the two most distant of the four photosensitive drums.

In the Modified Example, in order to effectively reduce an amount of dust reaching the rotatable polygon mirror 203 of the deflector 204 by air flow containing dust, etc. flowing inside the scanning optical device 30 from the openings portions H22 and H23 of the optical box 201, the optical box 201 has the following configuration. That is, to the optical box 201, in the Y direction, in a vicinity of the opening portion H22, which is the closest in distance from the deflector 204, a dust proof wall 230 is provided.

The dust proof wall 230 provided to the optical box 201 is disposed parallel to a longitudinal direction of the opening portion H22 and to stand from a bottom surface 201a of the optical box 201 toward the lid 202. For the opening portion H23, since a distance from the deflector 204 to the opening portion H23 is farther than to the opening portion H22, an air volume at the opening portion H23 is smaller than that at the opening portion H22. Therefore, in a vicinity of the opening portion H23, a dust proof wall may not be provided, or a low standing wall, which is lower than the dust proof wall 230 on the opening portion H22 side, of a degree not to affect the air flow flowing in and out of the opening portion H23 may be provided.

In the Modified Example, for the dust proof wall 230 provided between the opening portion H22 and the rotatable polygon mirror 203, a configuration in which the dust proof wall 230 is provided only to the optical box 201 is described. However, it may be a configuration of the two dust proof walls of a dust proof wall standing from the optical box 201 and a dust proof wall standing from the lid, and in addition, it may be a configuration in which the dust proof wall is provided only on the lid side.

As described above, according to the Modified Example, the air flow flowing in from the opening portion H23 side may reach the rotatable polygon mirror 203 of the deflector 204, however, the air volume of the air flow is smaller than that on the opening portion H22 side. Therefore, risk for the rotatable polygon mirror 203 to be contaminated by dust is lower than that on the opening portion H22 side. Therefore, by providing the dust proof wall in the vicinity of the opening portion closer to the deflector, which has the higher risk, it becomes possible to effectively prevent the entering of dust from outside air. In addition, since periphery of the deflector of the scanning optical device is not covered by a dust proof wall, trapping of heat in a space is prevented and it becomes possible to suppress temperature rise. By this, it becomes possible to provide a scanning optical device which can achieve both suppression of the temperature rise of the scanning optical device and improvement of dust proof performance and prevent the degradation of image quality.

As described above, according to the Embodiment 1, it becomes possible to suppress the rise of the ambient temperature around the deflector and effectively perform the dust proof around the deflector.

### Embodiment 2

Part (b) of FIG. 9 is a sub scanning cross-sectional outline view describing an Embodiment 2. A scanning optical device 31 is a scanning optical device in which an optical box is altered with respect to the scanning optical device 30 illustrated in part (a) of FIG. 9. The deflector provided with the rotatable polygon mirror encased in an optical box 301, the imaging lenses, and the reflecting mirrors have the same configurations as the scanning optical device 30 in the Embodiment 1, which is described using part (a) of FIG. 9. Therefore, for an internal configuration of the scanning optical device 31, description will be omitted, and the same reference numerals as in part (a) of FIG. 9 will be used for the same configurations as in part (a) of FIG. 9.

### Dust Proof Wall in the Embodiment 2

The Embodiment 2 effectively reduces an amount of dust reaching the rotatable polygon mirror 203 of the deflector 204 by air flow containing dust, etc. flowing inside the scanning optical device 31 from openings H32 and H33 of four openings H31, H32, H33 and H34 of the optical box 301. Therefore, in the optical box 301, in the Y direction, in a vicinity of the opening portion H32 as a first opening portion, which is the closest in distance from the deflector 204, a first dust proof wall 330 (first wall portion) is provided. The first dust proof wall 330 provided to the optical box 301 is disposed parallel to a longitudinal direction of the opening portion H32 and to stand from a bottom surface 301a of the optical box 301 toward the lid 202. The first dust proof wall 330 is provided at a position between the opening portion H32 and the deflector 204 and closer to the opening portion H32 in a direction perpendicular to the main scanning direction.

In the Y direction, in a vicinity of the opening portion H33 as a second opening portion disposed at a position closer in distance from the deflector 304 next to the opening portion H32, a second dust proof wall 340 (second wall portion) is provided. The second dust proof wall 340 provided to the optical box 301 is disposed parallel to a longitudinal direction of the opening portion H33 and to stand from the bottom surface 301a of the optical box 301 toward the lid 202. The second dust proof wall 340 is provided at a position between the opening portion H33 and the deflector 204 and closer to the opening portion H33 in the direction perpendicular to the main scanning direction.

For the opening portion H33, since a distance from the deflector 304 to the opening portion H33 is farther than to the opening portion H32, an air volume at the opening portion H33 is smaller than that at the opening portion H32. Therefore, a height Ht2 of the second dust proof wall 340 provided in the vicinity of the opening portion H33 is configured to be lower than a height Ht1 of the first dust proof wall 330 in the vicinity of the opening portion H32 (Ht2<Ht1). In this manner, on the opening portion H33 side, the second dust proof wall 340, which is a low standing wall of a degree in which temperature rise in ambient temperature around the deflector 304 caused by rotational drive of the deflector 304 does not become significant, is provided.

In the Embodiment 2, the dust proof wall provided between the opening portion and the rotatable polygon mirror is described as a configuration in which the dust proof wall is provided only to the optical box, however, as in FIG. 7 in the Embodiment 1, it may be a configuration of two dust proof walls of a dust proof wall provided to the optical box and a dust proof wall provided to the lid. That is, the first dust proof wall 330 may include a third wall portion extending from the optical box 301 toward the lid 202 and a fourth wall portion extending from the lid 202 toward the bottom surface 301a. And/or the second dust proof wall 340 may include a fifth wall portion extending from the optical box 301 toward the lid 202 and a sixth wall portion extending from the lid 202 toward the bottom surface 301a. Incidentally, when the fifth wall portion and the sixth wall portion are provided, it is configured to be a degree in which the temperature rise of the ambient temperature does not become significant. Furthermore, each of the third wall portion, the fourth wall portion, the fifth wall portion and the sixth wall portion may be constituted by a plurality of wall portions as the dust proof walls 131a and 131b in FIG. 7. In addition, it may be a configuration in which the dust proof wall is provided only on the lid side. Incidentally, a length in the main scanning direction of the first dust proof wall 330 is the same as or longer than a length of the opening portion H32 in the main scanning direction.

As described above, according to the Embodiment 2, air flow flowing in from the opening portion H33 side may reach the rotatable polygon mirror 303 of the deflector 304. However, since an air volume of the air flow is smaller than on the opening portion H32 side, risk for the rotatable polygon mirror 303 to be contaminated by dust is lower compared to the opening portion H32 side. Therefore, by providing a relatively large first dust proof wall 330 on the opening portion H32 side closer to the deflector 304, which has the higher risk, it becomes possible to effectively prevent the entering of dust. In addition, for the first dust proof wall 330 provided in the vicinity of the opening portion H32 and the second dust proof wall 340 provided in the vicinity of the opening portion H33, a height of each dust proof wall is optimized. By this, it becomes possible to balance the amount of dust entering the scanning optical device 31 and temperature rise in ambient temperature around the deflector caused by the deflector being driven. For example, for the second dust proof wall 340, when the height thereof is configured to be higher, it becomes possible to reduce dust further, and when the height thereof is configured to be lower, it becomes possible to prevent the temperature rise in the ambient temperature around the deflector 204 caused by the drive of the deflector 204. By this, it becomes possible to provide a scanning optical device which can achieve both suppression of the temperature rise of the scanning optical device and improvement of the dust proof performance, while achieving a balance between the temperature rise and the dust proof, and can improve image quality.

As described above, according to the Embodiment 2, it becomes possible to suppress the rise of the ambient temperature around the deflector and effectively perform the dust proof around the deflector.

### Embodiment 3

### Outline of an Image Forming Apparatus

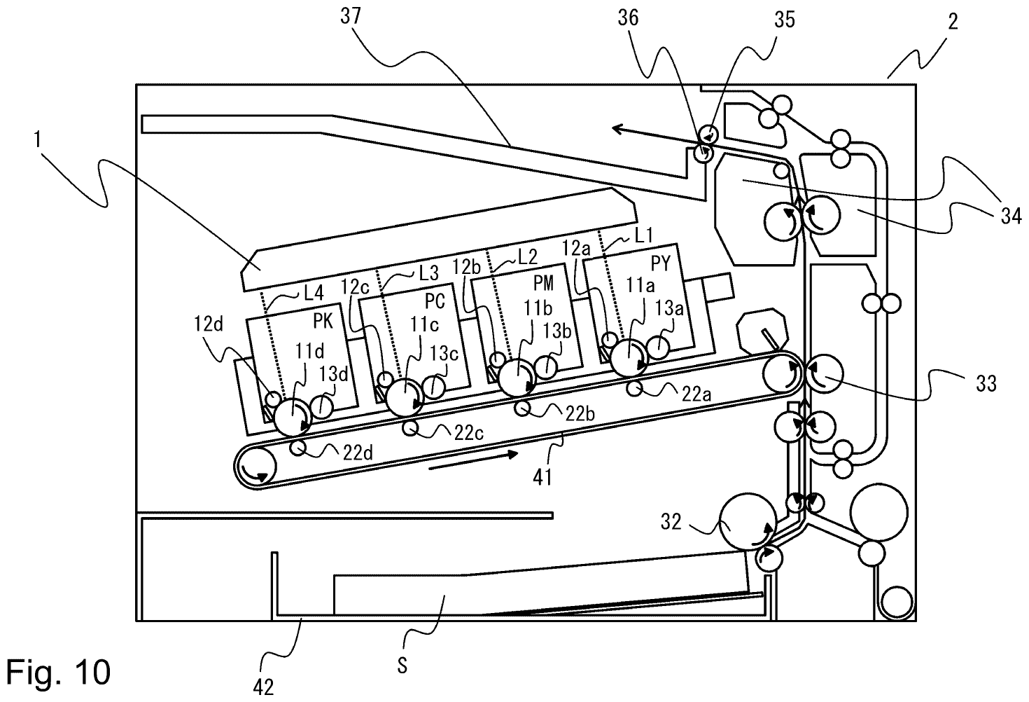

FIG. 10 is a cross-sectional outline view of an image forming apparatus 2 in the Embodiment 1. The image forming apparatus 2 in the Embodiment 1 is a color image forming apparatus which forms a full-color image by superimposing four colors of yellow, cyan, magenta and black. Next, an image forming process will be described. To process cartridges PY, PM, PC and PK which corresponds to each color, the photosensitive drums 11a, 11b, 11c and 11d as image bearing members, charging rollers 12a, 12b, 12c and 12d which are chargers, and developing rollers 13a, 13b, 13c and 13d which are developers are provided. Incidentally, the process cartridges PY, PM, PC and PK may be collectively referred to as a process cartridge P. In addition, for members provided to each process cartridge P, a represents yellow, b represents magenta, c represents cyan, and d represents black, and hereinafter, a through d of the members in the process cartridge P are also omitted except when a member of a particular color is described. The same applies to a primary transfer roller 22 described below.

The photosensitive drums 11, which are charged in advance by the charging rollers 12, are irradiated by laser luminous fluxes L1, L2, L3 and L4 emitted from the scanning optical device 1, which is an exposure device, so that electrostatic latent images are formed on surfaces thereof, respectively. The electrostatic latent image is turned into a toner image by the developing roller 13 as a developing means, and the toner image on the photosensitive drum 11 is transferred to an intermediary transfer belt 41 by the primary transfer roller 22 (primary transfer). Meanwhile, a recording paper S as a recording material placed in a paper cassette 42, which is disposed downside the intermediary transfer belt 41, is taken out by a pickup roller 32 timed with the image forming process. Thereafter, on the conveyed recoding paper S, the toner images of the four colors on the intermediary transfer belt 41 are transferred by a secondary transfer roller 33 as a transfer means (secondary transfer). By the recording paper S finally passing through a fixing device 34, the unfixed toner images are fixed, and the recording paper S is discharged by discharging rollers 35 and 36 to a discharge tray 37 outside the image forming apparatus 2.

As described above, according to the Embodiment 3, it becomes possible to suppress the rise of the ambient temperature around the deflector and effectively perform the dust proof around the deflector.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-062051 filed on Apr. 8, 2024, which is hereby incorporated by reference herein in its entirety.

What is claimed is:

1. A scanning optical device comprising:
a plurality of light sources;
a deflector including a rotatable polygon mirror for deflecting and scanning a plurality of laser lights emitted from the plurality of the light sources in a main scanning direction;
a beam detector configured to receive the laser light deflected by the deflector and output a signal;
an optical box including a bottom surface on which the deflector is provided; and
a lid member configured to cover the optical box,
wherein the optical box or the lid member includes a plurality of opening portions for permitting passing of each of the plurality of the laser lights to outside the scanning optical device,
wherein as viewed in the main scanning direction, a wall portion is provided between a first opening portion which is disposed at a position closest to the deflector of the plurality of the opening portions and the deflector, and between an inner space of the optical box on which the deflector is provided and an inner space of the optical box provided with the first opening portion,
wherein the wall portion is constituted by a first wall portion extended from the optical box toward the lid member and a second wall portion extended from the lid member toward the bottom surface,
wherein the wall portion is provided with a first light passing portion which is a hole portion for permitting passing of the laser light deflected by the deflector and a second light passing portion which is a hole portion for permitting passing of the laser light toward the beam detector of the laser light deflected by the deflector, and
wherein as the wall portion is viewed in an alignment direction of the plurality of the opening portions, in a space between the lid member and the bottom surface, substantially all areas excluding the first light passing portion and the second light passing portion are covered by the wall portion.

2. The scanning optical device according to claim 1, wherein the first wall portion and/or the second wall portion include a plurality of wall portions different in height in a standing direction.

3. The scanning optical device according to claim 1, wherein a length of the wall portion in the main scanning direction is the same as a length of the opening portions in the main scanning direction or longer than the length of the opening portion.

4. A scanning optical device comprising:
a plurality of light sources;
a deflector including a rotatable polygon mirror for deflecting and scanning a plurality of laser lights emitted from the plurality of the light sources in a main scanning direction;
an optical box including a bottom surface on which the deflector is provided; and
a lid member configured to cover the optical box,
wherein the optical box or the lid member includes a plurality of opening portions for permitting passing each of the plurality of the laser lights to outside the scanning optical device, and
wherein as viewed in the main scanning direction, the plurality of the opening portions include a first opening portion which is disposed at a position closest to the deflector of the plurality of the opening portions and a second opening portion which is disposed at a position closer to the deflector next to the first opening portion;
a first wall portion standing from the bottom surface or the lid member and provided between the first opening portion and the deflector; and
a second wall portion standing from the bottom surface or the lid member and provided between the second opening portion and the deflector,
wherein a height of the first wall portion is higher than a height of the second wall portion.

5. The scanning optical device according to claim 4, wherein the first wall portion includes a third wall portion extended from the optical box toward the lid member and a fourth wall portion extended from the lid member toward the bottom surface, and/or
wherein the second wall portion includes a fifth wall portion extended from the optical box toward the lid member and a sixth wall portion extended from the lid member toward the bottom surface.

6. The scanning optical device according to claim 5, wherein the third wall portion, the fourth wall portion, the fifth wall portion and/or sixth wall portion include a plurality of wall portions different in height in a standing direction.

7. The scanning optical device according to claim 4, wherein a length of the first wall portion in the main scanning direction is the same as a length of the opening portions in the main scanning direction or longer than the length of the opening portions.

8. An image forming apparatus for forming a toner image on a recording material, the image forming apparatus comprising:
an image bearing member configured to bear an electrostatic latent image;
a scanning optical device according to claim 1 and configured to form the electrostatic latent image;
a developing means configured to develop the electrostatic latent image and form the toner image; and
a transfer means configured to transfer the toner image to the recording material.
